(19) United States
(12) Patent Application Publication
(10) Pub. No.: US 2026/0091829 A1
(43) Pub. Date: Apr. 2, 2026

(54) REFUSE COLLECTION VEHICLE DETENT DEVICE

(71) Applicant: The Heil Co., Chattanooga, TN (US)

(72) Inventors: Ethan Lee Maness, Rainsville, AL (US); Mark Fraas, Centre, AL (US)

(21) Appl. No.: 19/348,471

(22) Filed: Oct. 2, 2025

Related U.S. Application Data
(60) Provisional application No. 63/702,460, filed on Oct. 2, 2024.

(51) Int. Cl. B62D 33/037; B65F 3/24

(52) U.S. Cl. CPC B62D 33/037; B65F 3/24

(57) ABSTRACT

A detent device is disclosed, comprising a fixable housing, a slide bearing surface, a plunger, a spring, a bracket, and a detent element. The housing defines an axis. The slide bearing surface is coupled to a portion of the fixable housing. The plunger is at least partially constrained by the slide bearing surface and configured to slide along the axis between a proximal end position and a distal end position. The spring exerts a biasing force on the plunger in a direction towards the distal end position. The bracket is configured to slide together with the plunger. The detent element is mounted to the bracket. The detent element is configured to be biased into a recess of a contoured guide surface by the biasing force of the spring. The detent element is further configured to climb out of the recess when a component of a force applied through the contoured guide surface overcomes the biasing force of the spring to move the plunger towards the proximal end position.

### CROSS-REFERENCE TO RELATED APPLICATIONS

This application claims the benefit under 35 U.S.C. § 119(e) of U.S. Patent Application No. 63/702,460, entitled “Refuse Collection Vehicle Detent Device,” filed October 2, 2024, which is incorporated herein by reference in its entirety.

### TECHNICAL FIELD

This disclosure relates to the field of refuse collection vehicles.

### BACKGROUND

Refuse collection vehicles have been used for generations to collect and transfer refuse. Many refuse collection vehicles include a mechanism, such as an arm or tipper assembly, to engage refuse containers and dump the contents into an onboard compartment. After collection, the refuse is generally compacted to reduce its volume and increase the carrying capacity of the refuse collection vehicle. When the refuse collection vehicle reaches a landfill, its tailgate is opened and an ejector expels the compacted refuse. While such refuse collection vehicles have long been serviceable, there remains a need for further improvements.

### SUMMARY

Aspects of this disclosure are directed to refuse collection vehicles.

In one aspect, a detent device includes a fixable housing, a slide bearing surface, a plunger, a spring, a bracket, and a detent element. The fixable housing defines an axis. The slide bearing surface is coupled to a portion of the fixable housing. The plunger is at least partially constrained by the slide bearing surface. The plunger is configured to slide along the axis between a proximal end position and a distal end position. The spring exerts a biasing force on the plunger in a direction towards the distal end position. The bracket is configured to slide together with the plunger. The detent element is mounted to the bracket. The detent element is configured to be biased into a recess of a contoured guide surface by the biasing force of the spring. The detent element is further configured to climb out of the recess when a component of a force applied through the contoured guide surface overcomes the biasing force of the spring to move the plunger towards the proximal end position.

In another aspect combinable with the previous aspect, the detent device is an entirely passive mechanism.

In another aspect combinable with one or more of the previous aspects, the detent device is configured to create a snapping effect when the detent element enters the recess.

In another aspect combinable with one or more of the previous aspects, the detent element is a linear roller, a spherical roller, a non-rolling element, a pin, or a tapered pin.

In another aspect combinable with one or more of the previous aspects, the biasing force is 500 lbf when the detent element is retained in the recess and 1000 lbf when the detent element is completely outside the recess on the contoured guide surface.

In another aspect combinable with one or more of the previous aspects, the spring can be a plurality of springs to adjust the degree of displacement of the springs and/or the biasing force.

In another aspect combinable with one or more of the previous aspects, the housing comprises a proximal housing portion, an intermediate housing portion, and a distal housing portion. The proximal housing portion is a bottomed hollow cylinder including a first female thread at its distal end. The intermediate housing portion is a hollow cylinder including a second male thread at its proximal end and a third male thread at its distal end. The distal housing portion is a hollow cylinder including a fourth female thread at its proximal end.

In another aspect combinable with one or more of the previous aspects, the proximal housing portion is configured to entirely accommodate the spring regardless of a position of the plunger between the proximal end position and the distal end position.

In another aspect combinable with one or more of the previous aspects, the intermediate housing portion includes the slide bearing surface at its radial inner wall.

In another aspect combinable with one or more of the previous aspects, the biasing force is adjustable by the first and second threads. Additionally or alternatively, the proximal end position and/or the distal end position are adjustable by the first and second threads.

In another aspect combinable with one or more of the previous aspects, the position of the housing along the axis is adjustable by the third and fourth threads.

In another aspect combinable with one or more of the previous aspects, the plunger is a rod including a plate shaped flange at its proximal end and a blind hole including a fifth female thread at its distal end.

In another aspect combinable with one or more of the previous aspects, the bracket includes a sixth male thread at its proximal end and a mounting element for the detent element at its distal end. The mounting element can be an axle.

In another aspect combinable with one or more of the previous aspects, the position of the housing along the axis is fixable by a nut including a seventh female thread.

In another aspect, a refuse vehicle tailgate detent device includes a fixable housing, a slide bearing surface, a plunger, a spring, a bracket, and a detent element. The fixable housing defines an axis. The housing is fixedly attachable to a frame of a tailgate of a refuse vehicle. The slide bearing surface is coupled to a portion of the fixable housing. The plunger is at least partially constrained by the slide bearing surface. The plunger is configured to slide along the axis between a proximal end position and a distal end position. The spring exerts a biasing force on the plunger in a direction towards the distal end position. The bracket is configured to slide together with the plunger. The detent element is mounted to the bracket. The detent element is configured to be biased into a recess of a contoured guide surface by the biasing force of the spring. The guide surface is movable relative to the frame. The detent element is further configured to climb out of the recess when a component of a force applied through the contoured guide surface overcomes the biasing force of the spring to move the plunger towards the proximal end position. This aspect can be combinable with one or more of the previous aspects.

In another aspect, a refuse vehicle ejector detent device includes a fixable housing, a slide bearing surface, a plunger, a spring, a bracket, and a detent element. The fixable housing defines an axis. The housing is fixedly attachable to a refuse container structure of a refuse vehicle. The slide bearing surface is coupled to a portion of the fixable housing. The plunger is at least partially constrained by the slide bearing surface. The plunger is configured to slide along the axis between a proximal end position and a distal end position. The spring exerts a biasing force on the plunger in a direction towards the distal end position. The bracket is configured to slide together with the plunger. The detent element is mounted to the bracket. The detent element is configured to be biased into a recess of a contoured guide surface by the biasing force of the spring. The guide surface is movable relative to the refuse container structure. The detent element is further configured to climb out of the recess when a component of a force applied through the contoured guide surface overcomes the biasing force of the spring to move the plunger towards the proximal end position. This aspect can be combinable with one or more of the previous aspects.

Certain embodiments of the detent devices, refuse collection bodies, and vehicles described throughout this disclosure may provide one or more of the following advantages: (1) mechanically locking operational components in place using a detent device to inhibit unintentional movement during refuse collection and/or transport; (2) mechanically locking operational components in place using a detent device that requires no dedicated actuator or power input (e.g., the lock is entirely “passive”); (3) increasing driver safety via the detent device by foregoing manually-operated locks; (4) increasing reliability via the detent device, e.g., by operating the lock without user interference or input, and/or by foregoing components prone to wear and/or fail in the field; (5) increasing the robustness of the refuse collection vehicle against human operating errors and equipment failure via an automatically-actuated, mechanical detent device.

Various additional features, objects, and advantages will be apparent from the following description and drawings, and from the claims.

### DESCRIPTION OF DRAWINGS

FIG. 1 is a side view of a side-loading refuse collection vehicle featuring one or more detent devices of the present disclosure.

FIG. 2A is a perspective view of an example detent device of the present disclosure.

FIG. 2B is another perspective view of the example detent device.

FIG. 2C is a side view of the example detent device.

FIG. 3 is a side sectional view of the example detent device.

FIG. 4 is an exploded perspective view of the example detent device.

FIG. 5 is an exploded side view of the example detent device.

FIG. 6A is a perspective view of a portion of a refuse vehicle tailgate featuring a detent device of the present disclosure.

FIG. 6B is an enlarged view of FIG. 6A that focuses on the detent device.

FIG. 6C is an enlarged view of FIG. 6A that focuses on the detent device and omits select components compared to FIG. 6B.

FIG. 7 is a perspective view of a refuse collection body featuring a detent device of the present disclosure.

FIG. 8A is a perspective view of a portion of an ejector featuring a detent device of the present disclosure.

FIG. 8B is a front view of the ejector and detent device of FIG. 8A.

FIG. 8C is another perspective view of the ejector and detent device of FIG. 8A.

### DETAILED DESCRIPTION

Embodiments of the present disclosure feature a detent device for a refuse collection vehicle that is configured to mechanically lock components of the refuse collection vehicle against unintentional relative movement. Among other advantages, the detent device has a simple structure, is space and cost-efficient, reduces energy consumption, promotes safety, and increases reliability of the refuse collection vehicle.

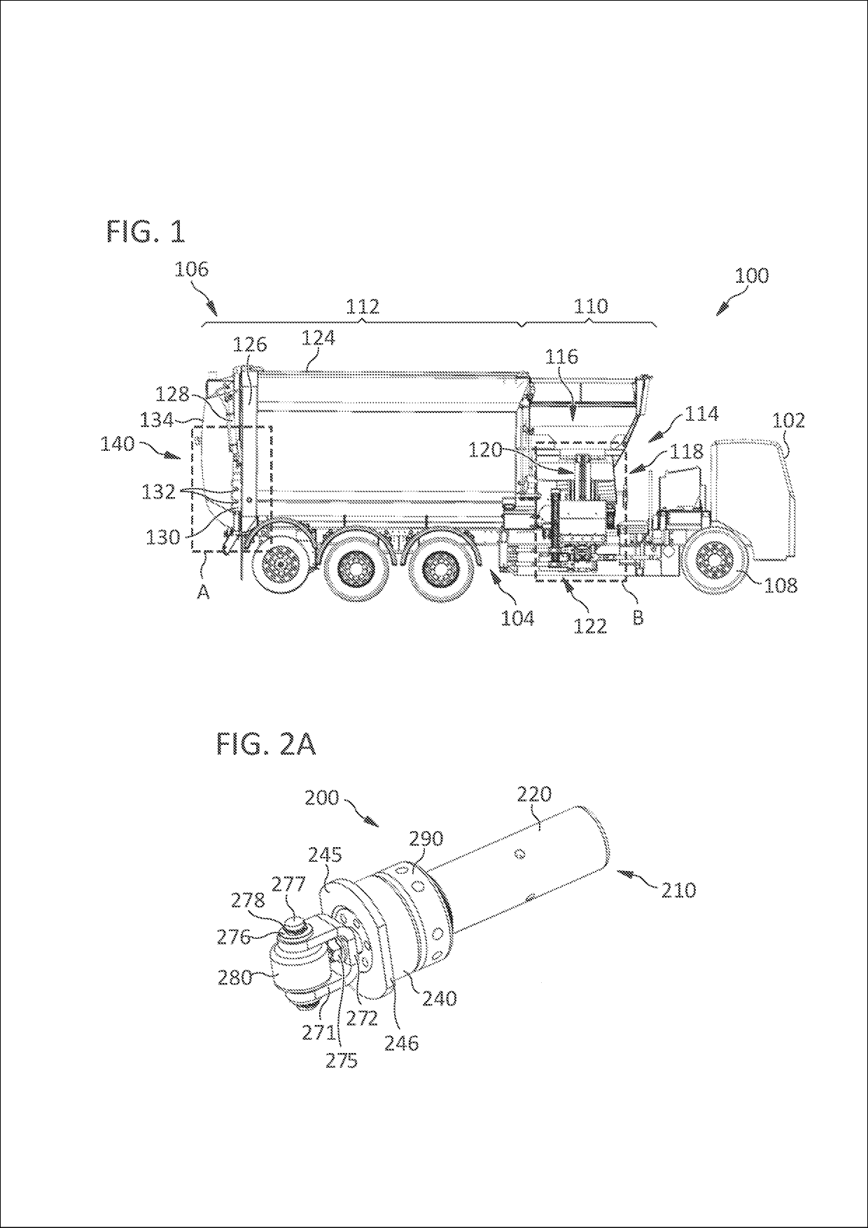

FIG. 1 depicts a vehicle 100 for collecting and transporting refuse (e.g., garbage). Refuse collection vehicles such as vehicle 100 are often described colloquially as a garbage collection vehicles or just “garbage trucks.”

Refuse collection vehicle 100 can be operated to collect and transport refuse. Refuse vehicle 100 can be configured to lift containers that contain refuse and empty the refuse from the containers into a hopper 116 of the refuse vehicle 100, to enable transport of the refuse to a collection site, compacting of the refuse, and/or other refuse handling activities. Refuse collection vehicle 100 can also handle containers in other ways, such as by transporting the containers to another site for emptying.

Refuse collection vehicle 100 includes a cab 102, a chassis 104, and a refuse collection body 106. Cab 102 includes a compartment for a driver of vehicle 100. The compartment is equipped with controls that enable the driver to operate various elements of chassis 104 and refuse collection body 106. Chassis 104 includes a power train (e.g., a diesel, compressed natural gas/CNG, or electric power train). Power train, which includes a prime mover and a drivetrain, converts and transfers motive power to the wheels 108 that move vehicle 100 on a road surface along a forward direction of travel (towards the right side in FIG. 1) and a rearward direction of travel (towards the left side in FIG. 1). For ease of discussion, we reference the direction across vehicle 100 and orthogonal to the forward/rearward directions as a transverse direction.

In the presented example, the refuse collection vehicle 100 is a so-called side loader.

Refuse collection body 106 includes a refuse intake portion 110 and a refuse storage portion 112. Refuse intake portion 110 includes refuse loading system 114 and hopper 116. Refuse loading system 114 is operable to transfer the contents of refuse containers into refuse collection body 106 via hopper 116. Refuse collection body 106 can include a packing device (not shown). The packing device can pack refuse loaded into the hopper 116, push refuse toward the rear of the refuse collection vehicle 100 (e.g., to refuse storage portion 112), and/or eject refuse from the refuse collection vehicle 100.

Refuse loading system 114 includes refuse container emptying system 118. Refuse container emptying system 118 includes container lift mechanism 120 and grabber 122. Grabber 122 can be operated to couple to a refuse container. Container lift mechanism 120 can be operated to lift the refuse container and tip and dump contents of the refuse container into hopper 116.

In some implementations, refuse collection vehicle 100 is an at least partially or all-electric vehicle. For example, some or all of the motive power and various body controls and sub-systems on the vehicle (including refuse loading system 114, a packing device, an ejector 150, etc.) can be electrically powered.

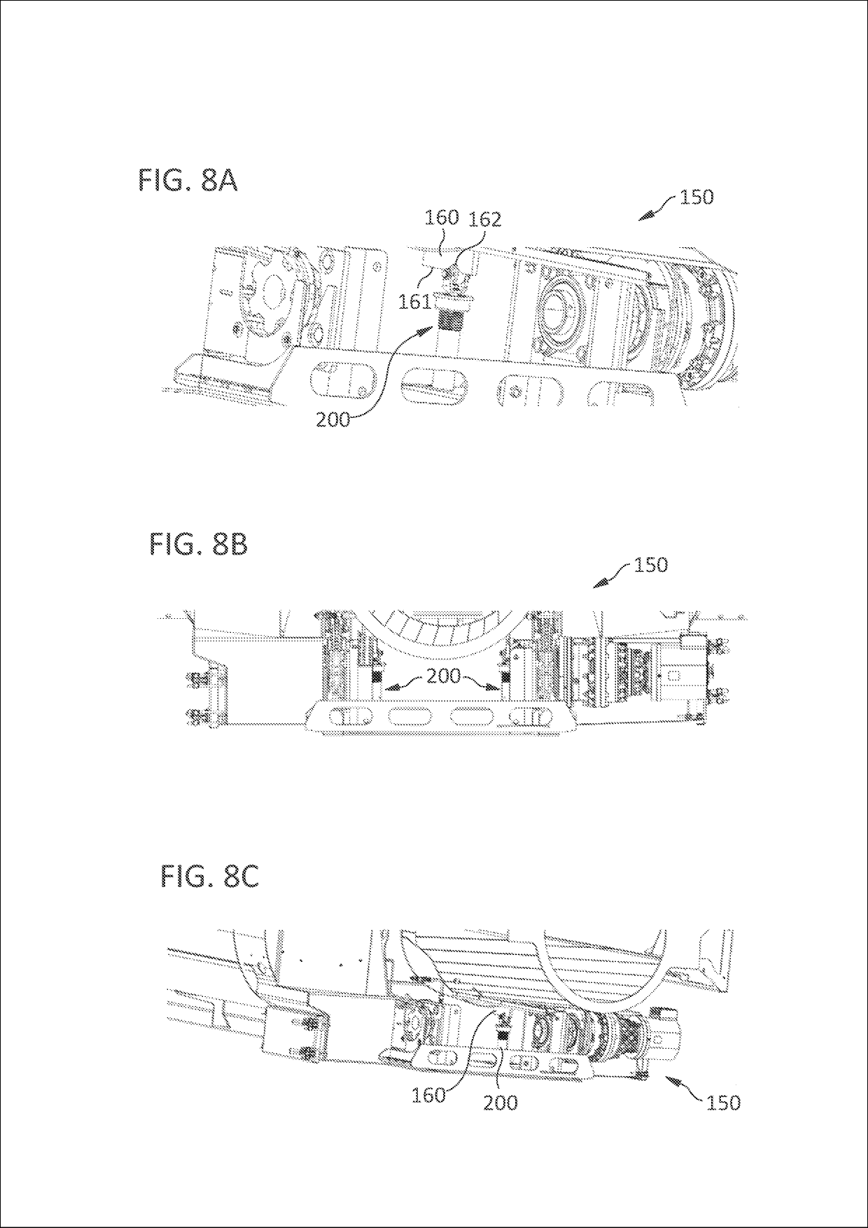

Additional operational components of refuse collection body 106 include a pivoting tailgate 134 for controlling access to an opening of storage container 124, a tailgate pivoting mechanism 140, and the ejector 150 (FIGS. 8A-8C) for expelling waste from storage container 124 when tailgate 134 is pivoted upward to an open position (clockwise in FIG. 1).

The refuse collection body 106 further includes a frame 126 that can be integral with the storage container 124 and/or that can be part of a wall of the storage container 124.

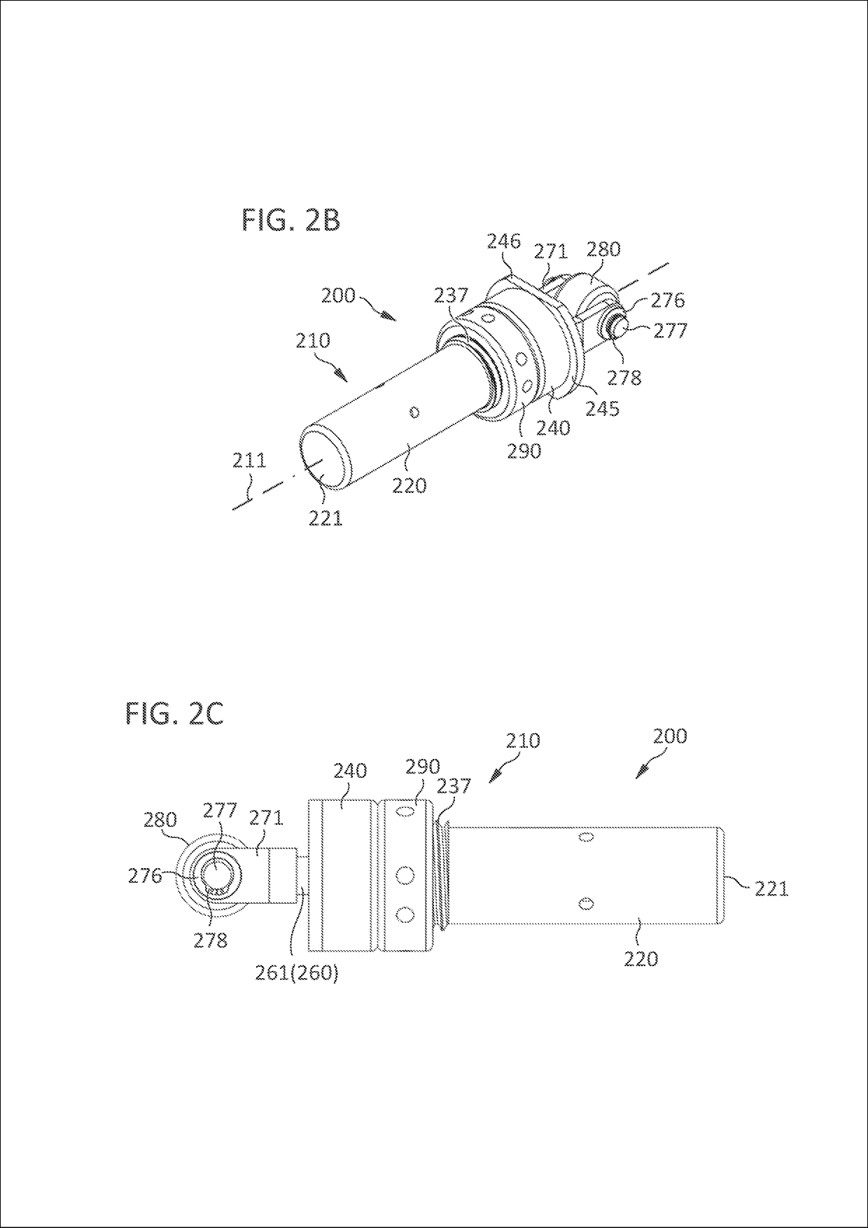

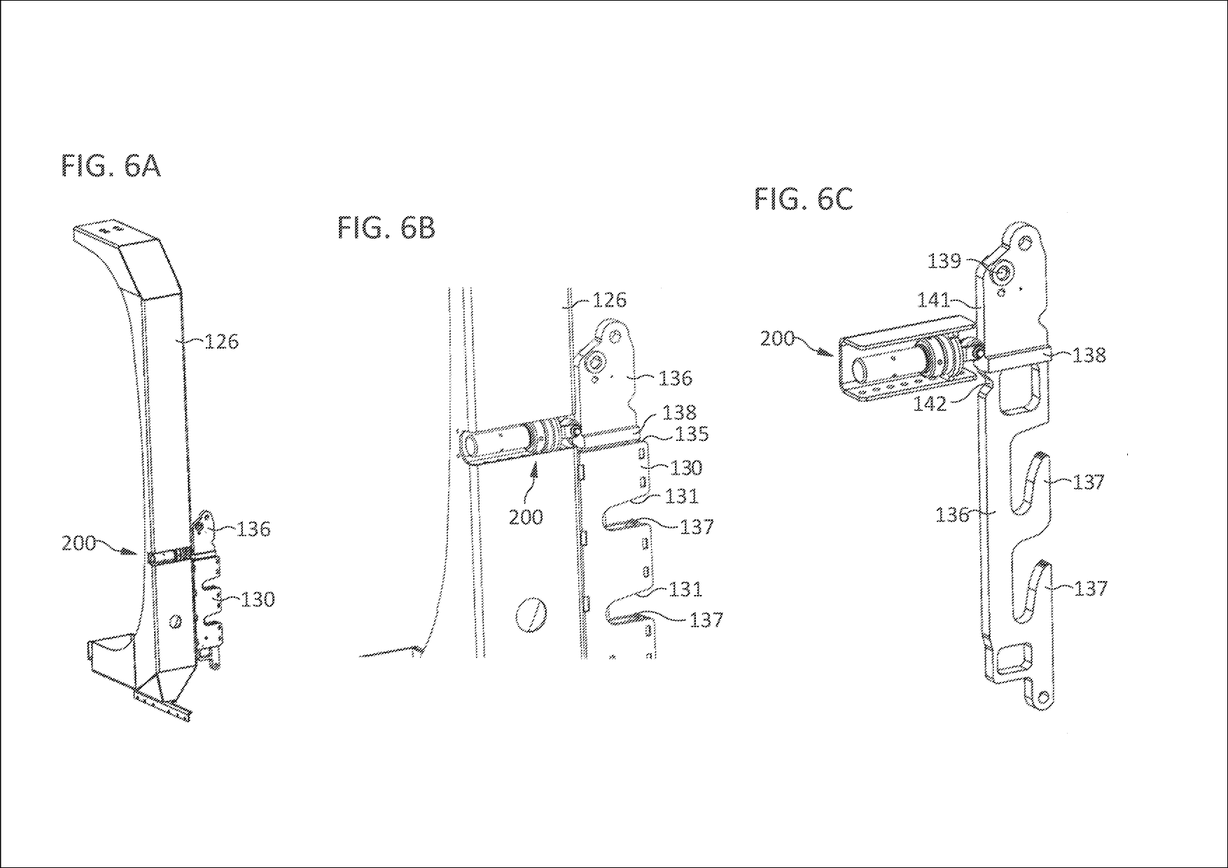

The tailgate pivoting mechanism 140 includes the frame 126, a tailgate actuator 128 (e.g., a hydraulic cylinder or a linear actuator), a guide plate 130, guide pins 132, a lock plate 136 (FIG. 6C), and a detent device 200 (e.g. FIGS. 2A-2C).

In FIG. 1, the tailgate 124 is shown in a closed position. The opening/closing operation of the tailgate 124 using the tailgate pivoting mechanism 140 will be explained further below.

In FIG. 1, the two dashed line boxes A and B show the areas of the refuse collection vehicle 100 in which the detent device 200 of the present disclosure can be used. For example, the detent device 200 can be used in the tailgate pivoting mechanism 140 (as indicated by A), the ejector 150 (as indicated by B), and/or the refuse loading system 114 (as also indicated by B).

FIGS. 2A-2C are external views of the detent device 200. FIG. 2A is a perspective front view of the detent device 200. FIG. 2B is a perspective rear view of the detent device 200. FIG. 2C is a side view of the detent device 200.

As shown in FIGS. 2A and 2B, the detent device 200 can have a generally cylindrical shape. Particularly the housing 210 of the detent device 200 can have a generally cylindrical shape, and more specifically can have a generally rotationally symmetrical shape relative to the axis 211 shown in FIG. 2B.

The axis 211 corresponds to a longitudinal axis of the detent device 200 that is defined by the housing 210.

The detent device 200 of the present disclosure has a distal end that corresponds to the end of the detent device at which a detent element (such as a roller 280) is arranged and a proximal end that is opposite to the distal end with reference to the axis 211. That is, in FIG. 2C, the distal end corresponds to the left end of the detent device 200 and the proximal end corresponds to the right end of the detent device 200.

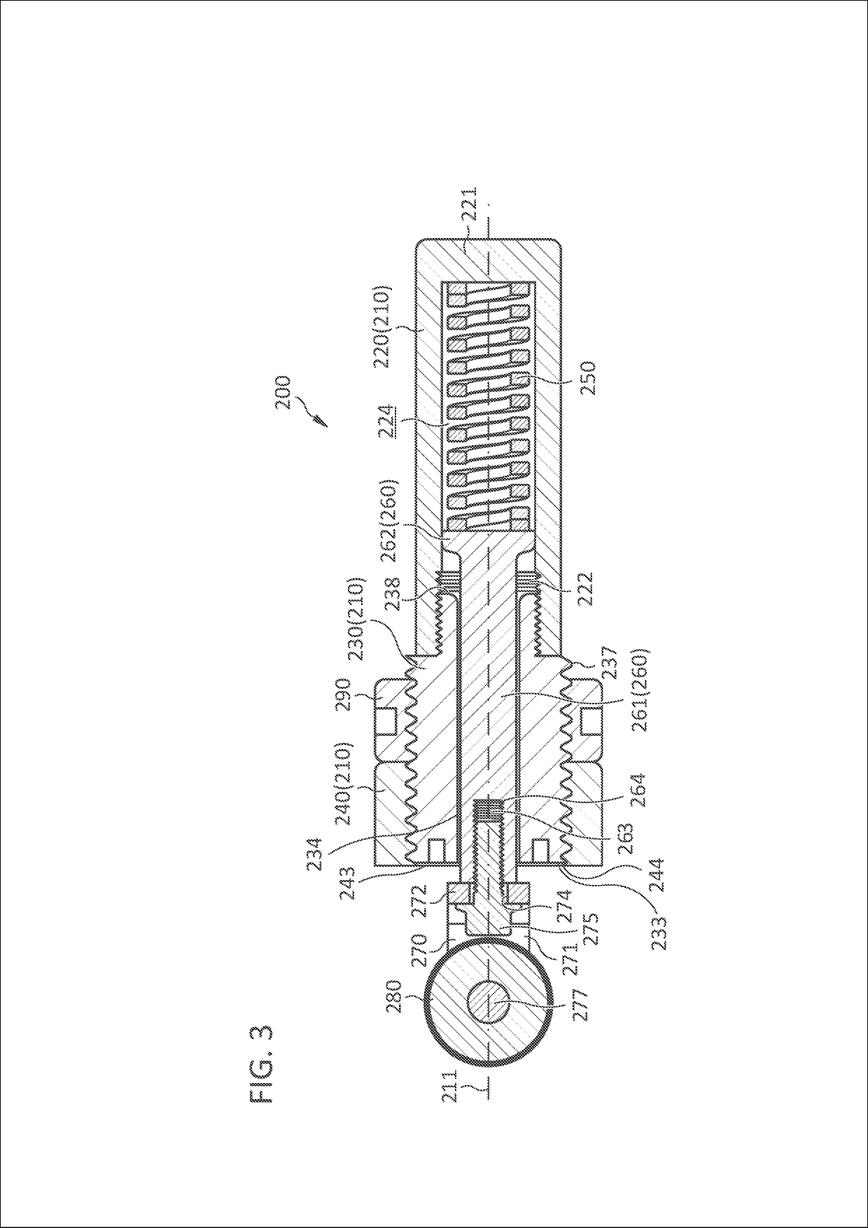

FIG. 3 is a sectional side view of the detent device 200 according to the present invention. As shown in FIG. 3, the housing 210 of the detent device 200 can include three housing portions: a proximal housing portion 220, an intermediate housing portion 230, and a distal housing portion 240. The proximal housing portion 220 is a portion of the housing 210 that is arranged at the proximal end of the detent device 200 with reference to the axis 211. The distal housing portion 240 is a portion of the housing 210 that is arranged at the distal end of the detent device 200 with reference to the axis 211. The intermediate housing portion 230 is a portion of the housing 210 that is generally arranged between the proximal housing portion 220 and the distal housing portion 240 in the direction of the axis 211. One of the functions of the intermediate housing portion 230 can be to establish a connection between the proximal housing portion 220 and the distal housing portion 240.

In the presented example, the proximal housing portion 220 is a bottomed hollow cylinder. The bottom 221 of the proximal housing portion 220 is at the proximal end of the detent device 200. The proximal housing portion 220 defines an inner bore 224.

One of the functions of the proximal housing portion 220 can be to accommodate a spring 250 and a part of a plunger 260, which reside within the inner bore 224.

The proximal housing portion 220 has a (first) female thread 222 at its distal end (i.e., the end closest to the intermediate housing portion 230). The distal end of the proximal housing portion 220 is the end that is opposite the bottom 221 along the axis 211. The proximal end of the proximal housing portion 220 is at the bottom 211.

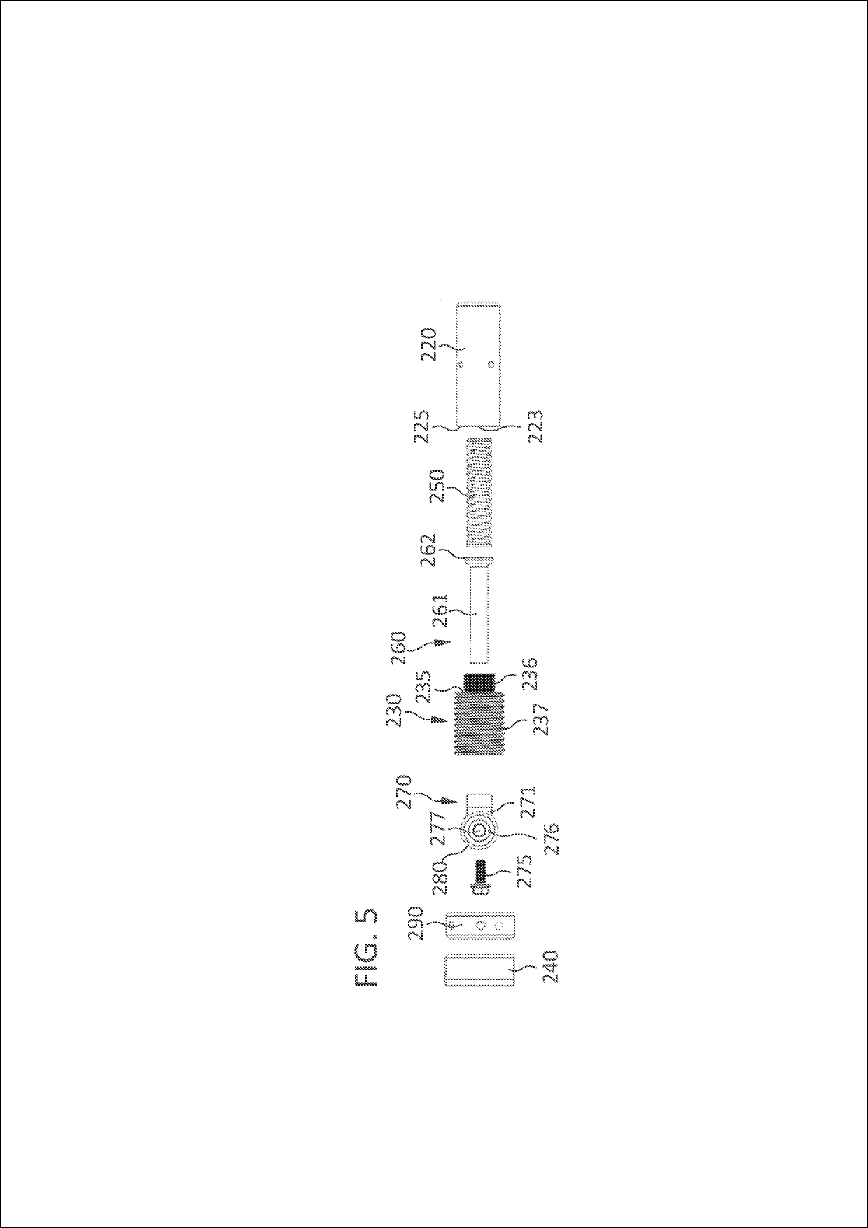

At its distal end, the proximal housing portion 220 includes an opening 223. The opening 223 is defined in an end face 225 (FIG. 5) of the proximal housing portion 220. The end face 225 can be an annular, ring shaped face of the proximal housing portion 220. The opening 223 communicates with and provides an aperture to the inner bore 224 of the proximal housing portion 220. For example, the spring 250 can be inserted into the proximal housing portion 220 and into the inner bore 224 through the opening 223 during assembly of the detent device 200. In this example, the proximal portion of the plunger 260 and the proximal end of the intermediate housing portion 230 are also inserted into the proximal housing portion 220 (the inner bore 224) through the opening 223.

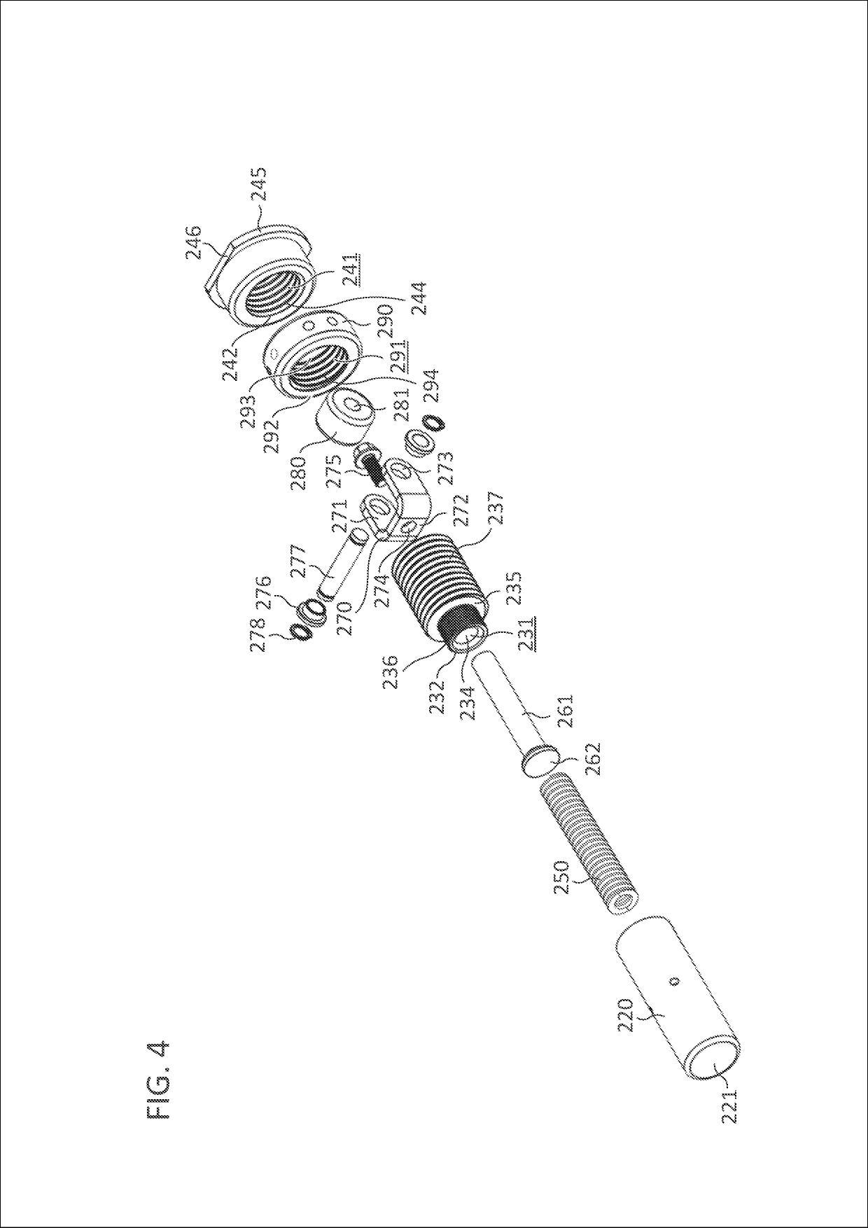

In this example, the intermediate housing portion 230 is a hollow cylinder. The intermediate housing portion 230 defines an inner bore 231 (FIG. 4). The inner bore 231 extends between an opening 232 (FIG. 4) at the proximal end of the intermediate housing portion 230 and an opening 233 (FIG. 3) at the distal end of the intermediate housing portion 230.

In this example, substantially the entire inner surface of the intermediate housing portion 230 forms a slide bearing surface 234 on which the plunger 260 can slidably reciprocate (e.g., alternately move along the axis 211 towards the proximal end of the detent device 200 and towards the distal end of the detent device 200). The plunger 260 is configured to move (e.g., slide) along the axis 211 between a proximal end position and a distal end position.

In this example, the outer surface of the intermediate housing portion 230 is a stepped surface. In other words, the outer surface includes a step 235 (FIG. 4). In the presented example, a portion of the intermediate housing portion 230 on the proximal side of the step 235 has a smaller outer diameter than a portion of the intermediate housing portion 230 on the distal side of the step 235.

The step 235 of the intermediate housing portion 230 can be used as an abutment surface (can include an abutment surface that is ring shaped in the present example) at which the end face 225 of the proximal housing portion 220 can abut the intermediate housing portion 230.

In this example, the intermediate housing portion 230 has a (second) male thread 236 at its proximal end (FIG. 4). The (second) male thread 236 of the intermediate housing portion 230 is configured to be threadedly engaged with the (first) female thread 222 of the proximal housing portion 220 for releasably connecting the proximal housing portion 220 and the intermediate housing portion 230.

In this example, the intermediate housing portion 230 has a (third) male thread 237 at its proximal end. The (third) male thread 237 of the intermediate housing portion 230 is configured to be threadedly engaged with a (fourth) female thread 244 of the distal housing portion 240 for releasably connecting the distal housing portion 240 and the intermediate housing portion 230.

In this example, the distal housing portion 240 is a hollow cylinder. The distal housing portion 240 defines an inner bore 241 (FIG. 4). The inner bore 241 extends between an opening 242 (FIG. 4) at the proximal end of the distal housing portion 240 and an opening 243 (FIG. 3) at the distal end of the distal housing portion 240.

In this example, substantially the entire inner surface of the distal housing portion 240 forms the (fourth) female thread 244 that is configured to be threadedly engaged with the (third) male thread 237 of the intermediate housing portion 230.

In this example, at least a portion of the outer surface of the distal housing portion 240 is configured to be fixed to another structural component of the refuse vehicle, such that the detent device 200 as a whole is not movable and not rotatable relative to that other component. To illustrate, FIG. 4 shows that the distal housing portion 240 can include a flange 245 at its distal end. The flange 245 can include two flattened surfaces 246 to facilitate the fixing of the distal housing 240 (and thus the detent device 200 as a whole) to the other structural component. For example, the flattened surfaces 246 can be used to avoid rotation of the detent device 200 relative to the other component.

Referencing FIG. 1, the structural component to which the detent device 200 can be fixed may include the frame 126, the storage container 124, or a part of the ejector 150, as will be described further below.

Turning back to FIGS. 1-5, in this example, the plunger 260 includes a rod portion 261 and a flange portion 262. The rod portion 261 has an elongated solid (e.g., a non-hollow) body. The rod portion 261 of the plunger 260 is the part of the plunger 260 that is configured to slide on the slide surface 234 of the intermediate housing portion 230. At its proximal end, the plunger 260 integrally includes the flange portion 262. The flange portion 262 has a larger outer diameter than the rod portion 261 and terminates in a planar surface. Accordingly, the flange portion 262 can be used as an abutment portion for the spring 250 and/or as a stopper of the plunger 260 that is configured to prevent the plunger 260 from moving further towards the distal end of the detent device 200. For example, the flange portion 262 can abut an end face 238 (FIG. 3) at the proximal end of the intermediate housing portion 230 to thereby stop the axial movement of the plunger 260 towards the distal end of the detent device 260.

An abutment of the flange portion 262 and the end face 238 can define a distal end position of the plunger 260 in its movement along the axis 211.

In this example, the plunger 260 further includes a blind hole 263 at its distal end. The blind hole 263 extends from an opening in an end face at the distal end of the plunger 260. Substantially the entire inner surface of the blind hole 263 includes a (fifth) female thread 264.

In the presented example, the spring 250 that is mounted in the proximal housing portion 220 (i.e. arranged between the bottom 221 and the flange portion 262) is pre-tensioned. In other words, the mounted spring 250 is not relaxed. For example, the spring 250 is half deformed in the distal end position of the plunger 260. In this position, the displacement of the spring 250 mounted in the proximal housing portion 220 is at a minimum (relative to an unmounted state of the spring 250). In this state, the spring 250 exerts a force of approximately 500 lbf (1 lbf ≈ 4.448 N). When the plunger 260 is in the proximal end position, the displacement of the spring 250 is at a maximum. In this state, the spring 250 exerts a force of approximately 1000 lbf.

In the presented example, the bracket 270 is generally U-shaped. The bracket 270 has two arms 271 and a base 272 that connects the arms 271. The arms 271 and the base 272 can generally have the shape of flat elongates plates. The arms 271 each include a through hole 273. The base 272 also includes a through hole 274.

In the presented example, the bracket 270 is releasably mounted to the (distal end of the) plunger 260 by a screw 275. The screw 275 is inserted through the hole 274 in the base 272 and is threadedly engaged with the (fifth) female thread 264 in the blind hole 263 of the plunger 260. Thus, the bracket 270 is integral with the plunger 260 and is configured to slide together with the plunger 260.

The through holes 273 of the arms 271 are configured to each accommodate a bearing bushing 276. The bearing bushings 276 are hollow cylinders that each have an inner surface. The inner surface acts as a bearing surface for an axle 277 of a roller 280.

In the present example, the outer surface of each bearing bushing 276 is formed as a stepped surface having a cylindrical portion with a smaller diameter and a plate shaped flange portion with a larger diameter. The cylindrical portion is insertable into the through holes 273. The flange portion serves as a stopper that abuts the arm 271 to hold the bearing bushing 276 in a desired position.

In the presented example, during assembly of the detent device 200, the axle 277 is inserted into the bearing bushing 276 on one side of the bracket 270. The bearing bushing 276 is, in turn, inserted into the corresponding though hole 273 of the arm 271 on the one side. Next, the axle 277 is inserted through a through hole 281 of the roller 280 that has been arranged between the arms 271 of the bracket 270 after the bracket 270 has been fixed to the plunger 260 by the screw 275. At this point, the axle 277 is inserted through the other bearing bushing 276 on other side of the bracket 270. The other bearing bushing 276 is, in turn, inserted into the corresponding though hole 273 of the arm 271 on the other side. Finally, the axle 277 is secured in position by two circlips 278 that are inserted into grooves at both longitudinal ends of the axle 277.

In this example, the detent device further includes a lock nut 290. The lock nut 290 is a hollow cylinder. The lock nut 290 defines an inner bore 291 (FIG. 4). The inner bore 291 communicates with the outside of the lock nut 290 through an opening 292 (FIG. 4) at the proximal end of the lock nut 290 and an opening 293 at the distal end of the lock nut 290.

In this example, substantially the entire inner surface of the lock nut 290 forms a (seventh) female thread 294 that is configured to be threadedly engaged with the (third) male thread 237 of the intermediate housing portion 230.

The lock nut 290 may be used for securing the distal housing portion 240 from disengaging from the intermediate housing portion 230, e.g., due to vibrations of the detent device 200.

Above, the structure and the mounting of the detent device 200 has been described. Below, the exemplary integration of the detent device 200 in the refuse collection vehicle 100 will be described.

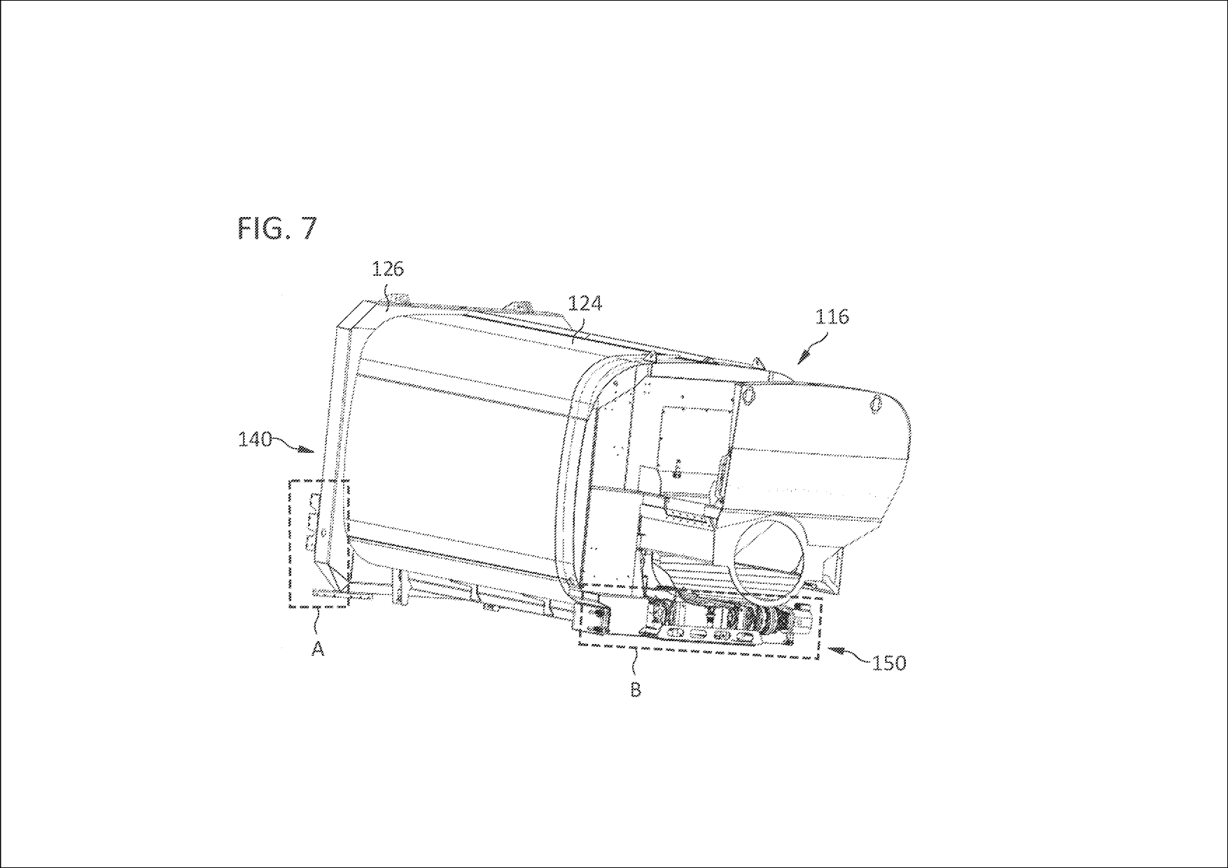

Turning to FIGS. 6A-6C, integration of the detent device 200 in the tailgate pivoting mechanism 140 (as indicated by A in FIG. 1 and FIG. 7) will be described.

In FIG. 1, the tailgate 134 is shown in a closed state. A fully opened state (not shown) of the tailgate 134 is a state in which the tailgate 134 is rotated (clockwise) about an axis in the upper part of the storage container 124 from the state shown in FIG. 1 by 10 degrees to 180 degrees, preferably by 45 degrees to 135 degrees, more preferably by more than 90 degrees (in particular by 95 to 120 degrees).

To avoid unintentionally discharging or spilling refuse from the storage container 124, the tailgate 134 can be locked in the closed position. The tailgate 134 includes the guide pins 132. In the closed state of the tailgate 134, the guide pins 132 are inserted into slits 131 of the guide plate 130, which is fixed to the frame 126 (storage container 124). The slits 131 are open to one side (to the rear of the refuse collection vehicle 100 or towards an opening direction of the tailgate 134) to receive the guide pins 132.

To secure the guide pins 132 in the slits 131, the slits 131 can be closed by protrusions 137 formed in the lock plate 136. The lock plate 136 is coupled to the tailgate actuator 128 via the through holes 139. When the tailgate actuator 128 is retracted, it pulls the lock plate 136 (FIG. 1). In this example, the tailgate actuator 128 pulls the lock plate 136 upwards (towards the rotation axis of the tailgate 134 or the locking position of the lock plate 136). When the tailgate actuator 128 is retracted, the protrusions 137 close the slits 131 such that the guide pins 132 cannot exit the slits 131. In this state, the tailgate 134 is locked in the closed position.

To open the tailgate 134, the tailgate actuator 128 is expanded. When the tailgate actuator 128 expands, it pushes the lock plate 136 (downwards or away from the rotation axis of the tailgate 134, or towards the release position of the lock plate 136) until an abutment portion 138 of the lock plate 136 abuts an abutment face 135 of the guide plate 130. When the abutment portion 138 abuts the abutment face 135, the protrusions 137 have opened (released) the slits 131 (FIG. 6B). When the tailgate actuator 128 is further expanded, it cannot expand further downwards due to the abutment (form fit) of the abutment portion 138 and the abutment face 135. Therefore, the tailgate actuator 128 expands upwards. Thus, the tailgate 134 is rotated about its rotation axis (in a clockwise direction in FIG. 1) while the guide pins 132 are guided out of the slits 131 (towards the rear of the refuse collection vehicle 100) along the upper walls of the slits 131 that are inclined upwards to facilitate the exit of the guide pins 132. Once the guide pins 132 have been moved out of the slits 131, the tailgate 134 can freely rotate to its fully open position.

Between the opening operations, the closed tailgate 134 is locked and secured in that the guide pins 132 are inhibited from exiting the slits 131 by the protrusions 137. To prevent unintentional release of the guide pins 132 from the slits 131, it has been known to insert a locking pin through a hole penetrating the guide plate 130 and the lock plate 136. This solution typically requires a human operator to leave the vehicle cab and manually insert the locking pin in place when the tailgate is closed and to manually remove the locking pin before the tailgate is opened. The detent device 200 of this disclosure provides an improved solution.

As shown in FIGS. 6A-6C, the detent device 200 can be fixed to the frame 126. Specifically, the distal housing portion 240 of the detent device 200 can be fixed to the frame 126 (the storage container 124) of the refuse collection vehicle 100. The roller 280 of the fixed detent device 200 is biased against a contoured guide surface 141 of the lock plate 136 by the spring 250. The guide surface 141 includes a recess 142. The recess 142 is positioned such that when the lock plate 136 is in the lock position (i.e., in a position in which the protrusions 137 close the slits 131), the roller 280 is biased into the recess 142. In other words, in the lock position of the lock plate 136, the roller 280 enters the recess 142 of the guide surface 141.

The recess 142 has inclined side surfaces to facilitate the movement of the roller 280 into and out of the recess 142. The inclined side surfaces of the recess 142 further ensure that a pushing force of the tailgate actuator 128 generates a force component along the axis 211 of the detent device 200. When the force component becomes larger than the biasing force of the spring 250, the roller 280 (plunger 260) starts moving into the proximal direction of the detent device 200. Accordingly, the roller 280 starts moving out of the recess 142 to enable relative movement of the lock plate 136 and the guide plate 130.

The biasing force exerted by the spring 250 is adjusted such that it can be overcome by the component of the force exerted by the tailgate actuator 128 (in the direction of the axis 211) during the opening operation of the tailgate 134 and that it cannot be overcome by (components of) forces acting on the lock plate 136 during other uses of the refuse collection vehicle 100 such as vibrations during traveling of the refuse collection vehicle 100.

As described above, the biasing force of the spring 250 when the roller 280 is in the recess 142 can be, for example, 500 lbf, and can be 1000 lbf when the roller 280 is on the guide surface 141 outside the recess 142. This creates a snapping effect when the roller 280 enters the recess 142. Accordingly, the retention effect by the detent device is improved.

For example, the tailgate actuator 128 is configured to generate 500 psi, and even up to 1800 psi (1 psi ≈ 6,895 kPa).

The application of the detent device 200 of the present disclosure described above concerns the tailgate pivoting mechanism 140 (as indicated by A in FIG. 1 and FIG. 7). Another application of the detent device 200 of the present disclosure concerns the ejector 150 (as indicated by B in FIG. 1 and FIG. 7) as will be described below.

For example, when the refuse collection vehicle 100 is traveling or standing on an inclined road surface such that the refuse collection vehicle 100 is tilted backwards (i.e., the front of the refuse collection vehicle 100 is higher that the tail) and the vehicle is (further) accelerated by the driver, a large force can be exerted on the ejector 150 towards the tailgate 128 by the content of the storage container 124.

Generally, the ejector 150 is configured to push refuse through and out of the storage container 124 during an unloading sequence by moving along a longitudinal axis of the storage container 124 between first and second ends within the storage container 124 and relative to a floor of the storage container 124.

Accordingly, a situation during a normal use of the refuse collection vehicle 100 can occur in which the forces acting on the ejector 150 are high enough to result in an unintended unloading sequence of the refuse.

To avoid unintended unloading of the refuse, a motor of the ejector 150 that drives (components such as an ejector panel of) the ejector 150 along the longitudinal axis of the storage container 124 to unload the refuse via the opened tailgate 128 could be provided with a brake. However, this could increase the complexity of the motor and increase the costs of the refuse collection vehicle 100. Alternatively, the unintended unloading could be prevented by constantly applying torque by the motor in a direction opposite to the driving direction for the unloading operation. However, this could increase power consumption of the motor. Especially in an all-electric refuse collection vehicle 100 reducing the power consumption is an important design goal.

The detent device 200 of the present disclosure can be used to avoid the unintended unloading of refuse. As shown in FIGS. 8A-8C, the detent device 200 can be used with or be included in the ejector 150 of the refuse collection vehicle 100.

The ejector 150 includes rails 160 that are movable along the longitudinal axis of the storage container 124, e.g., together with an ejector panel (not shown) of the ejector 150. The rails 160 include a contoured guide surface 161. The guide surface includes a recess 162. The guide surface 161corresponds to the guide surface 141. The recess 162 corresponds to the recess 142 The detent mechanism 200 is fixed relative to the rails 160 (the ejector panel). The axis 211 of the detent mechanism is arranged substantially perpendicular to the moving direction of the rails 160 (the ejector panel or the longitudinal axis of the storage container 124).

When the roller 280 of the detent mechanism is within the recess 162 of the rail 160, the ejector 150 (ejector panel) is prevented from moving along the longitudinal axis of the storage container 124 due to external forces acting on the ejector 150 (ejector panel) such as the weight of the refuse in the storage container 124 and/or the forces resulting from the acceleration of the refuse collection vehicle 100. When the motor of the ejector 150 drives the ejector 150 for unloading of the refuse, the force exerted by the motor is large enough to overcome the biasing force of the spring 250 of the detent mechanism 200 and to move the roller 280 out of the recess 162. Thus, the unloading of the refuse can be conducted as usual.

The function of the detent mechanism 200 as described in connection with the ejector 150 (dashed boxes B in FIGS. 1 and 7) corresponds to that as described in connection with the tailgate pivoting mechanism 140 (dashed boxes A in FIGS. 1 and 7).

Another application of the detent device 200 according to the present disclosure is in connection with or as part of the refuse loading system 114 (refuse container emptying system 118) of the refuse collection vehicle 100. For example, the detent device 200 can be used to hold (retain) a lifting arm of the refuse container emptying system 118, e.g., during driving (turns) of the refuse collection vehicle 100. For example, the detent mechanism 200 could be used to retain the lifting arm during a left turn of the refuse collection vehicle 100.

Still other applications of the detent device 200 according to the present disclosure are possible.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

A number of embodiments have been described. Nevertheless, it will be understood that various modifications may be made without departing from the spirit and scope of the disclosure. Accordingly, other embodiments are within the scope of the following claim(s).

For example, while the cab 102 of the refuse collection vehicle 100 is described above as featuring a compartment for a human driver, in some embodiments the refuse collection vehicle 100 can be operated autonomously or semi-autonomously.

As another example, the refuse collection vehicle 100 is described above as a so-called side loader. However, in some embodiments, the refuse collection vehicle can be a front-loading refuse collection vehicle including a front lift assembly or a rear loading refuse collection vehicle including a container emptying system at the rear side of the refuse collection vehicle near the tailgate.

As yet another example, the detent device 200 is described above as having a generally cylindrical shape. However, in some embodiments, the shape of the detent device can generally be cuboid or a prism having an elliptical basal area. Any suitable shape is included in the present disclosure.

As yet another example, the housing 210 is described above as having a generally a cylindrical shape, and more specifically having a rotationally symmetrical shape. However, in some embodiments, the housing can have an axial symmetry relative to the axis 211 or no symmetry at all.

As yet another example, the housing 210 is described above as including three housing portions. However, the housing can include less or more portions, e.g., two, four, five, six, etc. The housing can also be a monolithic housing being made from one piece. Such a housing can be made by additive manufacturing, for example.

As yet another example, the detent element is mainly described above as being the roller 280. However, in some embodiments, the detent element can be a specific roller such as linear roller or a spherical roller, or can be a non-rolling detent element, a (tapered) pin, a spherical or rounded end portion of the plunger or the like. Additionally or alternatively, the bracket can be formed much simpler that the one described above. In fact, the structure of the bracket can correspond or can be reduced to a connecting portion of the detent element and the rest of the plunger. What is even more, in case of a non-rolling detent element, the bracket can be even completely dispensed with if the detent element and the plunger are a monolithic structure.

As yet another example, the intermediate housing portion 230 is described above as a a portion of the housing 210 that is generally arranged between the proximal housing portion 220 and the distal housing portion 240 in the direction of the axis 211. However, in some embodiments, the proximal housing portion and the distal housing portion can overlap in the direction of the axis 211. In such embodiments, the intermediate housing portion is arranged at least partially between the proximal housing portion and the distal housing portion in a direction transverse to the axis 211 (e.g., in a radial direction of the detent device).

As yet another example, the detent device 200 is described above as including specific (combinations of) male and female threads. However, in some embodiments, the proximal housing portion can include a male thread and the intermediate housing portion can include a corresponding female thread. Further, the intermediate housing portion can include two female threads instead of two male threads. The distal housing portion can include a corresponding male thread. In such an embodiment, the housing can be fixable at the intermediate housing portion. Further, the plunger can include a male thread and can be fixable to the bracket by a female thread (e.g. by a nut).

As yet another example, the slide bearing surface 234 (slide surface) is described above as substantially corresponding to the entire inner surface of the intermediate housing portion 230. However, in some embodiments, only a part of the inner surface of the intermediate housing portion can correspond to the slide surface. Additionally or alternatively, (parts of) the proximal housing portion and/or the distal housing portion can correspond to the slide surface.

As yet another example, the outer surface of the intermediate housing portion 230 is described above as a stepped surface. However, in some embodiments, the outer surface of the intermediate housing portion can have a substantially constant outer dimension or diameter. The dimensions of the other housing portions can be adapted accordingly.

As yet another example, substantially the entire inner surface of the distal housing portion 240 is described above as forming the (fourth) female thread 244. However, in some embodiments, only a part of the inner surface can form the (fourth) female thread.

As yet another example, the plunger 260 is described above as including a rod portion 261 and a flange portion 262. However, in some embodiments, the flange portion can be omitted. In such embodiments, the plunger can have a substantially constant outer dimension or diameter. The spring can abut the proximal end of the rod portion. The movement of the plunger towards the distal end can be limited by the abutment of the detent element mounted to or integral with the plunger and the guide surface on which the detent element slides or rolls Further, other kinds of stoppers for the plunger can be used, such as a protrusion or step in at the distal end of the housing at which the plunger (rod portion) can abut.

As yet another example, the entire inner surface of the blind hole 263 is described above as including the (fifth) female thread 264. However, in some embodiments, only a part of the inner surface can include the (fifth) female thread.

As yet another example, a single spring 250 is described above. However, in some embodiments, the spring can include two distinct springs, a proximal spring and a distal spring, or more than two springs, such as three, four, five etc. The use of two or more springs makes it possible to adjust the parameters of the spring(s) to the desired values using readily available springs (off the shelf), i.e. without having to rely on springs specially designed for the detent device. This reduces the costs of the detent device and provides the desired spring parameters. The two or more distinct springs can be arranged in series or in parallel. For example, the flange portion of the plunger can be large enough such that two or more springs can abut it. Further, any useful combination of parallelly and serially arranged springs can be used in the detent device.

As yet another example, the spring 250 is described above as being mounted (in the proximal housing portion 220) in a pre-tensioned state. However, in some embodiments, the spring can be mounted in a fully expanded or relaxed state when the plunger is in the distal end position.

As yet another example, the force exerted by the spring 250 in the distal end position of the plunger 260 is described above as being approximately 500 lbf. However, in some embodiments, the force can also be in a range of 100 lbf to 900 lbf, preferably from 250 lbf to 750 lbf, more preferably from 400 lbf to 600 lbf.

As yet another example, the force exerted by the spring 250 in the proximal end position of the plunger 260 is described above as being approximately 1000 lbf. However, in some embodiments, the force can also be in a range of 500 lbf to 1500 lbf, preferably from 750 lbf to 1250 lbf, more preferably from 900 lbf to 1100 lbf.

As yet another example, the spring 250 is described above as a compression spring. However, in some embodiments, a structure of the detent device including one or more tension springs is conceivable.

As yet another example, the spring 250 is described above as a spiral spring. However, in some embodiments, other types of springs such as a leaf spring or a wave spring can be used.

Further, in some embodiments, different spring types can be combined.

As yet another example, the detent mechanism 200 is described above as including a spring 250 exerting the biasing force. However, in some embodiments, other types of elastic members such as solid bodies made, for example, from elastomers or foams, or compressible fluids (liquids or gases) can be used instead of the spring.

As yet another example, a generally U-shaped bracket 270 is described above that couples the plunger 260 and the roller 280 (detent member). However, in some embodiments, an L-shaped bracket (having only one arm) can be used. In other embodiments, the bracket can be any type of bearing that enables rotation of the detent member. In other embodiments, particularly in the embodiments in which the detent element is a non-rolling detent element (e.g., a sliding element), the bracket can be any type of coupling that enables the reciprocating movement of the detent element by coupling the detent element to the plunger. In such a case, the bracket can be a (simple) joint connection such as a weld or a bonding. The bracket can even be completely dispensed with if the non-rolling detent element and the plunger are formed monolithically (without a joint). In such an embodiment, the non-rolling detent element corresponds to the distal end of the plunger that slides on and is guided by the contoured guide surface.

As yet another example, the bracket 270 is described above as being mounted to the plunger 260 by means of the screw 275. However, in some embodiments, any type of releasable or permanent connection between the plunger and the bracket can be used, such as weld, bonding, a different type of screw connection etc.

As yet another example, the bracket 270 is described above as including the bearing bushings 276. However, in some embodiments, the bearing bushings can be omitted. In still other embodiments, the bracket can include another types of bearing that allow rotation of the detent element such as a ball bearing or a roller bearing.

As yet another example, the bracket 270 is described above as including the circlips 278. However, in some embodiments, pins or other securing elements can be used. Alternatively, no securing elements can be used, for example, if a shrink fit is used to secure the axle in its bearing.

As yet another example, the detent device is described above as including a lock nut 290. However, in some embodiments, the lock nut can be omitted. Further, other means for securing the distal housing portion can be used, such as adhesives or wires.

As yet another example, substantially the entire inner surface of the lock nut 290 is described above as forming the (seventh) female thread 294. However, in some embodiments, only a part of the inner surface can form the (seventh) female thread.

As yet another example, the tailgate 134 is described above as including the guide pins 132. However, in some embodiments, the tailgate can include only one pin. Alternatively, no pins can be used but, for example, (a) protrusion(s) at the tailgate.

As yet another example, slits 131 are described above as being formed in the guide plate 130. However, in some embodiments, the slits can be formed directly in the frame or in the storage container. Accordingly, the guide plate can be omitted (and the abutment portion can abut an abutment face or portion at the frame or in the storage container).

As yet another example, the ejector 150 has been described as including rails 160 that that include the contoured guide surface 161. However, in some embodiments, the guide surface can be formed, for example, directly in the ejector panel and the rails can be omitted.

What is claimed is:

1. A detent device, comprising:
a fixable housing defining an axis;
a slide bearing surface coupled to a portion of the fixable housing;
a plunger at least partially constrained by the slide bearing surface and configured to slide along the axis between a proximal end position and a distal end position;
a spring exerting a biasing force on the plunger in a direction towards the distal end position;
a bracket configured to slide together with the plunger; and
a detent element mounted to the bracket, the detent element configured to be biased into a recess of a contoured guide surface by the biasing force of the spring, the detent element further configured to climb out of the recess when a component of a force applied through the contoured guide surface overcomes the biasing force of the spring to move the plunger towards the proximal end position.

2. The detent device of claim 1, wherein
the detent device is an entirely passive mechanism.

3. The detent device of claim 1, wherein
the detent device is configured to create a snapping effect when the detent element enters the recess.

4. The detent device of claim 1, wherein
the detent element is a linear roller, a spherical roller, a non-rolling element, a pin, or a tapered pin.

5. The detent device of claim 1, wherein
the biasing force is 500 lbf when the detent element is retained in the recess and 1000 lbf when the detent element is completely outside the recess on the contoured guide surface.

6. The detent device of claim 1, wherein
the spring can be a plurality of springs to adjust the degree of displacement of the springs and/or the biasing force.

7. The detent device of claim 1, wherein
the housing comprises
a proximal housing portion being a bottomed hollow cylinder including a first female thread at its distal end,
an intermediate housing portion being a hollow cylinder including a second male thread at its proximal end and a third male thread at its distal end, and
a distal housing portion being a hollow cylinder including a fourth female thread at its proximal end.

8. The detent device of claim 7, wherein
the proximal housing portion is configured to entirely accommodate the spring regardless of a position of the plunger between the proximal end position and the distal end position.

9. The detent device of claim 7, wherein
the intermediate housing portion includes the slide bearing surface at its radial inner wall.

10. The detent device of claim 7, wherein
i) the biasing force and/or
ii) the proximal end position and the distal end position
are adjustable by the first and second threads.

11. The detent device of claim 7, wherein
the position of the housing along the axis is adjustable by the third and fourth threads.

12. The detent device of claim 1, wherein
the plunger is a rod including a plate shaped flange at its proximal end and a blind hole including a fifth female thread at its distal end.

13. The detent device of claim 1, wherein
the bracket includes a sixth male thread at its proximal end and an mounting element, such as an axle, for the detent element at its distal end.

14. The detent device of claim 1, wherein
the position of the housing along the axis is fixable by a nut including a seventh female thread.

15. A refuse vehicle tailgate detent device, the detent device comprising:
a fixable housing defining an axis, the housing being fixedly attachable to a frame of a tailgate of a refuse vehicle;
a slide bearing surface coupled to a portion of the fixable housing;
a plunger at least partially constrained by the slide bearing surface and configured to slide along the axis between a proximal end position and a distal end position;
a spring exerting a biasing force on the plunger in a direction towards the distal end position;
a bracket configured to slide together with the plunger; and
a detent element mounted to the bracket, the detent element configured to be biased into a recess of a contoured guide surface by the biasing force of the spring, the guide surface being movable relative to the frame, the detent element further configured to climb out of the recess when a component of a force applied through the contoured guide surface overcomes the biasing force of the spring to move the plunger towards the proximal end position.

16. A refuse vehicle ejector detent device, the detent device comprising:
a fixable housing defining an axis, the housing being fixedly attachable to a refuse container structure of a refuse vehicle;
a slide bearing surface coupled to a portion of the fixable housing;
a plunger at least partially constrained by the slide bearing surface and configured to slide along the axis between a proximal end position and a distal end position;
a spring exerting a biasing force on the plunger in a direction towards the distal end position;
a bracket configured to slide together with the plunger; and
a detent element mounted to the bracket, the detent element configured to be biased into a recess of a contoured guide surface by the biasing force of the spring, the guide surface being movable relative to the refuse container structure, the detent element further configured to climb out of the recess when a component of a force applied through the contoured guide surface overcomes the biasing force of the spring to move the plunger towards the proximal end position.
